(19) United States
(12) Patent Application Publication
(10) Pub. No.: US 2020/0157337 A1
(43) Pub. Date: May 21, 2020

(54) Water Soluble Polymer Dispersions

(71) Applicant: KEMIRA OYJ, Helsinki (FI)

(72) Inventors: Michael O'Toole, Marietta, GA (US); Danny Nguyen, Lilburn, GA (US)

(21) Appl. No.: 16/614,897

(22) PCT Filed: May 18, 2018
(86) PCT No.: PCT/US2018/033355

§ 371 Date: Nov. 19, 2019

Related U.S. Application Data
(60) Provisional application No. 62/508,866, filed on May 19, 2017.

(51) Int. Cl. C08L 33/26; C08K 3/32; C09K 8/584; C08L 33/02; C08K 3/30; C08K 3/26; C08K 3/36; C09K 8/588; C08L 43/02

(52) U.S. Cl. CPC C08L 33/26; C08K 3/32; C09K 8/584; C08L 33/02; C08K 3/30; C08K 3/26; C08K 2003/262; C09K 8/588; C08L 43/02; C08K 2003/324; C08L 2201/54; C08K 2003/3054; C08K 3/36

(57) ABSTRACT

Polymer compositions comprising: one or more polyacrylamide powders, one or more dispersants, one or more alkali metal or ammonium salts, fumed silica and water. The polymer composition offer improved stability over comparable polymer composition without fumed silica and alkali metal or ammonium salts. Also disclosed are methods of preparing the polymer compositions, treatment fluids comprising the polymer compositions, and methods of treating a portion of a subterranean formation with the treatment fluids.

### CROSS-REFERENCE TO RELATED APPLICATION

This application claims priority to U.S. Provisional Application No. 62/508,866, filed May 19, 2017.

### FIELD OF THE ART

The present disclosure relates to polymer compositions comprising dry polyacrylamides, which can be used in aqueous treatment fluids and used in methods for improving friction reduction properties of an aqueous treatment fluid.

### BACKGROUND

In a well stimulation operation, a large amount of fracturing fluid is pumped down a well bore hole under high pressure and at high flow rates to a depth of about 500 meters to 6 kilometers or more, causing the rock formation surrounding the well bore to fracture. The pressure is then relieved, allowing the oil to seep through the fractures into the well bore where it is pumped to the surface.

The turbulence produced as the fracturing fluid is pumped through the pipe under pressure results in the production of friction, thereby increasing the amount of energy required to move the amount of fluid at the same speed.

High molecular weight linear polymers may be used to alter the rheological properties of the fluid so that the turbulent flow is minimized, thereby preventing consequent energy loss in the fluid as it is pumped through the pipe.

Dry polymers are often used in these applications due to the high polymer concentration available in this form as compared to solution polymers. However, dry polymers can be difficult to dissolve, and have a dusting tendency, requiring special equipment as well as significant energy and water consumption to assure adequate makedown of the dry polymer into an active dilute form. In remote drilling locations equipment, energy and water are often in short supply and require significant financial input to secure. Emulsion polymers or oil-based dispersions may have logistic costs, settling over time and environmental issues such as VOC or required surfactants. For example, U.S. Pat. No. 4,673,704 describes certain aqueous polymer dispersions which comprise high molecular weight water soluble polymers, which become stable with gentle mixing. However, preferably, water soluble polymer dispersions used in various applications today would be ready to use on site without any agitation or mixing.

### BRIEF SUMMARY

In view of the foregoing, one or more embodiments described herein include a polymer composition comprising: one or more polyacrylamide powders, one or more dispersants, one or more alkali metal or ammonium salts, fumed silica and water. Another embodiment described herein is a method for improving the stability of polymer compositions comprising dry polyacrylamide powders and water, the method comprising: blending dry polyacrylamide powder and fumed silica to form a mixture; and combining the mixture with an aqueous solution of one or more dispersants and one or more alkali metal or ammonium salts to form a polymer composition. Also disclosed herein are methods of preparing the polymer compositions, treatment fluids, comprising the polymer compositions and water; and methods for improving the friction reduction properties of an aqueous treatment fluid with the polymer compositions. Another embodiment described herein is a method of treating a portion of a subterranean formation, comprising: providing the treatment fluid and introducing the treatment fluid into the portion of the subterranean formation.

The disclosure may be understood more readily by reference to the following detailed description of the various features of the disclosure and the examples included therein.

### DETAILED DESCRIPTION

In view of the foregoing, there is an ongoing need to develop friction reducing agents for use in fracturing fluids that solve certain handling and stability, as well as homogeneity and viscosity, issues associated with using dry polymers in these fluids. There will be no need for expensive temperature control equipment.

According to the various embodiments described herein, polymer compositions comprise one or more polyacrylamide powders, one or more dispersants, one or more alkali metal or ammonium salts, fumed silica and water. Without being bound by theory, the components of the composition facilitate the formation of a dispersion wherein the particles of polyacrylamide powder are surrounded by the dispersant to prevent agglomeration and allow the composition to be fluid. In certain embodiments, the polymer compositions described herein provide improved stability compared to similar polymer compositions prepared without the fumed silica and one or more alkali metal or ammonium salts. In embodiments, the polymer compositions are suitable for use in aqueous treatment fluids, including well treatment fluids, and can be used in methods for improving friction reduction properties of an aqueous treatment fluid.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. Unless otherwise specified, a polymer may be a “homopolymer” comprising two or more different recurring units formed by, e.g., copolymerizing two or more different monomers, and/or by chemicall

In embodiments, a polymer composition comprises one or more polyacrylamide powders, one or more dispersants, one or more alkali metal or ammonium salts, fumed silica and water. In embodiments, the polymer composition remains substantially homogeneous, stable and free-flowing (i.e. low viscosity) for at least about 1 day, about 1 week, about 2 weeks, about 3 weeks, about 4 weeks, about 1 month, or about 3 months without agitation.

In embodiments, the polymer composition is in the form of an aqueous polymer dispersion. In embodiments, the polymer composition is a solid, or does not comprise an internal phase within another phase. In embodiments, the polymer composition is in the form of a suspension or a slurry. In embodiments, the polymer composition comprises polyacrylamide powder particles surrounded by fumed silica and one or more dispersants. Without being bound by theory, the fumed silica and dispersants may prevent agglomeration and hydration of the polyacrylamide powder particles.

In embodiments, the composition comprises about 2% to about 24%, about 4% to about 22%, about 6 to about 20%, or about 8 to about 18%, of the one or more polyacrylamide powders by weight of the total composition. In certain embodiments, if the polymer solids content of the composition is too low, the composition may separate and may have diminished friction reduction performance. In certain embodiments, if the polymer solids content of the composition is too high, the composition may gel, have a high viscosity, or have lower stability. In certain embodiments, a composition having low polymer solids content may be optimized with smaller particle sizes (e.g., less than about S75 μm, or less than 180 μm, as measured with a sieve).

In embodiments, the pH of the composition should be about 5 to about 10, or about 6 to about 8. In certain embodiments, if the pH of the composition is too low, the composition may gel, and if the pH of the composition is too high, the composition may be viscous or separate into two or more phases. In certain embodiments, the pH of the composition is adjusted with any suitable acid or base, such as sodium hydroxide, ammonium hydroxide, or hydrochloric acid. In certain embodiments, when preparing the composition, the dispersant is added to water and then the pH of the composition is adjusted prior to the addition of other components in the composition.

In embodiments, the standard viscosity (SV) is in the range of about 2 to about 9, about 3 to about 8.5, 4 to about 8.25, or about 5 to about 8 cP, as measured by a viscometer equipped with an ultra low viscosity spindle. In embodiments, the Brookfield viscosity of the composition at 25° C. is in the range of about 100 to 8000 cP, 200 to about 6000 cP, or about 300 to about 1000 cP.

In embodiments, the average particle size of the polymer solids in the composition is in the range of about 37 μm to about 1 mm, about 74 μm to about 1 mm, about 105 μm to about 850 μm, about 150 μm to about 600 μm, or about 200 μm to about 400 μm as measured by sieve analysis. In certain embodiments, greater than about 80, 85, 90 or 95% of the polymer solids in the composition are of a particle size in the range of about 37 μm to about 1 mm, about 74 μm to about 1 mm, about 105 μm to about 850 μm, about 150 μm to about 600 μm, or about 200 μm to about 400 μm, as measured by sieve analysis. In certain embodiments, if the size of the polymer particles in the composition is too small, the composition may have low polymer SV, and diminished friction reduction performance, and lower particle sizes may require more dispersant and/or cause the composition to have lower stability. In certain embodiments, if the size of the polymer particles in the composition is too large, the composition may take longer to reach maximum friction reduction (Tmax), and/or may have diminished friction reduction performance. In embodiments, the particle size can be predetermined for a necessary or desired result, such as a desired combination or balance of these effects.

In embodiments, the composition comprises about 0.5 to about 4%, about 1 at about 4%, about 0.8 to about 3%, abt 1 to about 2%, or about 1.2 to about 1.6% of the one or more alkali metal or mmonium salts by weight of the total composition. In certain embodiments, the ratio of the weight of the one or more alkali metal or ammonium salts to the weight of the dry polyacrylamide in the composition is in the range of about 0.08:1 to about 0.28:1, or about 0.12:1 to about 0.22:1, by weight.

In embodiments, the composition comprises about 0.1 to about 0.7%, about 0.2 to about 0.6, or 0.3 to about 0.5% of the fumed silica by weight of the totalv composition. In embodiments, the amount of fumed silica in the composition may depend at least in part on the amount of the polymer solids in the composition. For example, one may use more fumed silica in compositions having a higher amounts of polyacrylamide powder, or lesser amounts of fumed silica in compositions having lower amounts of polyacrylamide powder. In certain embodiments, if the amount of fumed silica in the composition is not sufficient, the composition may separate. In certain embodiments, if the amount of fumed silica in the composition is too high, the composition may become too viscous. In certain embodiments, the ratio of the weight of the fumed silica to the weight of the dry polyacrylamide in the composition is in the range of about 0.02:1 to about 0.05:1, or about 0.03:1 to about 0.04:1, by weight.

In embodiments, the one or more dispersants may include aqueous dispersants and/or dry dispersants. In certain embodiments, the composition comprises about 30 to about 50%, or about 35 to about 45% by weight aqueous dispersants. In embodiments, the solids content of the aqueous dispersants can be about 25 to 55% by cv bweight of the dispersants. In certain embodiments, the composition comprises about 13 to about 25%, or about 15 to about 23% dry dispersants by weight of the total composition. In certain embodiments, if the amount of the dispersant is too low, the composition may gel. In certain embodiments, if the amount of the dispersant is too high, the composition may become viscous and may have lower stability. In certain embodiments, such as when sathe particle size of the dry polyacrylamide is smaller, it may be beneficial to increase the amount of dispersant in the composition. In certain embodiments, the ratio of the weight of the dry dispersant to the weight of the dry polyacrylamide in the composition is in the range of about 1:1 to about 3.5:1, or about 1:1 to about 2:1, by weight.

In embodiments, water comprises the balance of the composition. The compositions comprise about 20 to about 45% water. In certain embodiments, if too little water is included, the composition may become viscous, or if too much water is included, the composition may separate.

In certain embodiments, the polymer compositions do not comprise a crosslinking agent. In certain embodiments, the polymer compositions do not comprise a polyol. In certain embodiments, the polymer compositions do not comprise a surfactant, for example a surfactant to stabilize the composition.

Polyacrylamide Powders (DPAMs)

In embodiments, the polyacrylamide powder, or dry polyacrylamide (DPAM), is an acrylamide-containing polymer or copolymer. In embodiments, the acrylag polymer or copolymer has a very high molecular weight, which is not generally quantifiable by typical methods. In embodiments, the acrylamide containing polymer or copolymer has a very high molecular weight, for example about 5,000,000 to about 50,000,000 daltons. In embodiments, the acrylamide containing polymer or copolymer has a standard viscosity of at least about 3.0 to 8.5 cP using ultra low viscosity adaptor for the measurement.

As used herein, the term “acrylamide polymer” refers to a homopolymer of acrylamide and encompasses acrylamide polymers chemically modified (e.g., hydrolyzed) following polymerization.

As used herein the term “acrylamide copolymer” or “acrylamide-containing copolymer” refers to a polymer comprising an acrylamide monomer and one or more comonomers. The comonomer may be anionic, cationic or non-ionic. In certain embodiments, the comonomer is hydrophilic. The acrylamide copolymer may be unmodified or chemically modified. Representative, non-limiting co-monomers include acrylic acid, vinyl acetate, vinyl alcohol and/or other unsaturated vinyl monomers. In certain embodiments, the acrylamide-containing copolymer comprises acrylic acid comonomers.

In one embodiment, the acrylamide copolymer comprises an anionic comonomer. In some embodiments, the anionic monomer is selected from the group consisting of (meth)acrylic acid, alkali/alkaline/ammonium salts of (meth)acrylic acid, 2-acrylamido-2-methylpropanesulfonic acid, alkali/alkaline/ammonium salts of 2-acrylamido-2-methylpropanesulfonic acid, maleic acid, alkali/alkaline/ammonium salts of maleic acid and the like. In certain embodiments, the acrylamide-containing copolymer comprises 2-acrylamido-2-methylpropanesulfonic acid comonomers.

In another embodiment, the acrylamide copolymer comprises a cationic comonomer. In some embodiments, the cationic monomer is selected from the group consisting of (meth)acrylamidoethyltrimethylammonium chloride, (meth)acrylamido propyltrimethylammonium chloride, diallyldimethylammonium chloride, and the like.

In another embodiment, the acrylamide copolymer comprises a non-ionic comonomer. In some embodiments, the non-ionic monomer is selected from the group consisting (meth)acrylamide, and maleic anhydride.

In embodiments, anionic or cationic monomers, included in the acrylamide copolymer, impart charge to the copolymer. The charge of the copolymer can be characterized by mole percent. In embodiments, the range of charge for the composition is a function of the charge of the polyacrylamide copolymer comprising charged monomers or the chemically modified polyacrylamide polymer or copolymer. In certain embodiments, the chemical modification can be, for example, partial hydrolysis of the copolymer.

In one embodiment, the acrylamide polymer or copolymer is characterized by a charge of about 4 mole % to about 100 mole %, or about 4 mole % to about 35 mole %.

In another embodiment, the acrylamide polymer or copolymer is characterized by a charge of at least about 4 mole %, about 10 mole %, about 15 mole %, about 20 mole %, about 25 mole %, about 30 mole %, about 35 mole %, about 40 mole %, or about 45 mole %. In an embodiment, the charge is an anionic charge. In certain embodiments, as the harshness of the brine decreases, a higher anionic charge on the acrylamide polymer or copolymer may result in improved performance.

In a particular embodiment, the acrylamide copolymer comprises from about 25 to about 95 mole % acrylamide or acrylamide containing monomers.

In embodiments, the dry polyacrylamide has a solids content of about 88% to about 100%, or about 88% to about 95%.

In a particular embodiment, the weight ratio of the acrylamide monomer to the one or more comonomers is about 1:99 to about 99:1, or about 70:30 to about 95:5. In certain embodiments, the polymer includes only acrylamide monomers.

In embodiments, acrylamide polymers or copolymers are water dispersible.

In embodiments, the polyacrylamide powder or dry polyacrylamide is a friction-reducing polymer.

Dispersants

In embodiments, the dispersant can be any suitable dispersant known in the art. In embodiments, the dispersant can be an aqueous dispersant or a dry dispersant. In embodiments, a blend of two or more dispersants can be used.

In embodiments, the dispersant can be a polymeric dispersant with a weight average molecular weight in the range of about 2200 to about 20000 Daltons. In certain embodiments, higher molecular weight dispersants (for example a weight average molecular weight greater than 10000 Daltons) may provide enhanced polymer separation.

In embodiments, the polymeric dispersant has a pH in the range of about 2.0 to about 10. In embodiments, the pH of the dispersant can be adjusted as necessary or desired, for example, to achieve a successful dispersion. Any suitable reagent (acid or base) can be used to adjust the pH. In certain embodiment, the pH is increased by the addition of sodium hydroxide, potassium hydroxide, or ammonium hydroxide.

In embodiments, any suitable amount of dispersant can be used in the compositions described herein, to produce a necessary or desired effect in the polymer composition. In certain embodiments, if the amount of the dispersant is too low, the composition may gel. In certain embodiments, if the amount of the dispersant is too high, the composition may become viscous and may have lower stability, e.g., resulting in phase separation. The amount and type of dispersant may be predetermined at least in part on the basis of these properties. In certain embodiments, the amount of dispersant used should be sufficient so as not to produce too viscous a dispersion, but should not be so high as to produce phase separation in the dispersion.

In embodiments, the polymeric dispersant is, for example, a polyacrylic acid polymer, a poly-phosphino carboxylic acid polymer, an acrylic acid and acrylamide copolymer, an acrylic acid and 2-acrylamido-2-methylpropane sulfonic acid copolymer, a poly(methacrylic acid) polymer, or a salt thereof. In particular embodiments, the following products, available from Kemira Oyj, could be used as dispersants in the polymer compositions described herein: Kemguard® 5802, Kemguard® 5803, Kemguard® 5804, Kemguard® 5805, Kemguard® 5807, Kemguard® 5811, Kemguard® 5812, Kemguard® 5817, Kemguard® 5826, Kemguard® 5840, Kemguard® 5861, Kemguard® 5865, Kemguard® 5870, KemEcal® 134, KemEcal® 135, KemEcal® 225, Colloid 142, Colloid 119-50, Colloid 284, PAA 2005, Colloid 207, Colloid 211, Colloid 102, Colloid 117-50, Colloid 260, Colloid 2640, Colloid 106, PAA-AMPS 2605, Colloid 237, Colloid 230, Colloid 134, Colloid 135, and Colloid 225. According to the embodiments, the polymeric dispersant may be a combination or blend of two or more dispersants. In certain embodiments, the dispersant may be determined, at least in part, ith consideration of the charge or ionic character of the polyacrylamide powder or DPAM. In certain embodiments, the dispersant is chosen with consideration of the dispersant solution viscosity, for example to avoid a resultant displasion phase separation.

In embodiments, when the polyacrylamide powder or DPAM is anionic or nonionic, the dispersant can be chosen from a polyacrylic acid polymer, a poly-phosphino carboxylic acid polymer, an acrylic acid and acrylamide copolymer, an acrylic acid and 2-acrylamido-2-methylpropane sulfonic acid copolymer, a poly(methacrylic acid) polymer, or a salt thereof. In particular embodiments, the following products, available from Kemira Oyj, could be used as dispersants in the polymer compositions described her44 hhhhhhhhhhhhhuiiiiiiiiiiiiiiiiiiiiiiiiiiiiiiiiiiiiiiiiiiiiiiiiiiiiiiiiiiiiiiiiiiiiih99999999999 ein: Kemguard® 5802, Kemguard® 5803, Kemguard® 5804, Kemguard® 5805, Kemguard® 5807, Kemguard® 5811, Kemguard® 5812, Kemguard® 5817, Kemguard® 5826, Kemguard® 5840, Kemguard® 5861, Kemguard® 5865, Kemguard® 5870, KemEcal® 134, KemEcal® 135, KemEcal® 225, Colloid 142, Colloid 119-50, Colloid 284, PAA 2005, Colloid 207, Colloid 211, Colloid 102, Colloid 117-50, Colloid 260, Colloid 2640, Colloid 106, PAA-AMPS 2605, Colloid 237, Colloid 230, Colloid 134, Colloid 135, and Colloid 225.

In embodiments, when the polyacrylamide powder or DPAM is cationic, the dispersant can be chosen from an ethoxylated alcohol or polydiallyldimethylammonium chloride, such as NOVEL® 23E7 and Fennofix 513, and cationic polymers such as Fennofix C1000 and Retaminol K, and the like.

Alkali Metal and Ammonium Salts

In embodiments, the polymer composition comprises one or more alkali metal or ammonium salts. In certain embodiments, the polymer composition comprises one or more ammonium salts. In certain embodiments, the polymer composition comprises one or more alkali metal salts, for example salts of lithium, sodium, potassium, rubidium, or cesium. In embodiments, the counterion of the alkali metal salt or ammonium salt can be any suitable counterion, including but not limited to, sulfate, halide (e.g. fluoride, chloride, bromide, iodide), or phosphate. In certain embodiments, the one or more alkali metal or ammonium salts comprises ammonium sulfate. In certain embodiments, the one or more alkali metal or ammonium salts comprises sodium chloride. In certain embodiments, the polymer composition comprises sodium sulfate.

Fumed Silica

In embodiments, the composition comprises fumed silica, or pyrogenic silica. In certain embodiments, the composition comprises hydrophilic fumed silica or untreated fumed silica. Fumed silica consists of microscopic droplets of amorphous silica fused into branched, chainlike, three-dimensional secondary particles which then agglomerate into tertiary particles. Fumed silica is made from flame pyrolysis of silicon tetrachloride or from quartz sand vaporized in a 3000° C. electric arc. Hydrophilic fumed silica products which can be used in the embodiments described herein, include for example, Aerosil 150, 200, 300, 380 (Evonik), Hydrophilic Cab-O-Sil (Cabot Corporation), and Hydrophilic HDK (Wacker Chemie).

In certain embodiments, the fumed silica has a surface area in the range of about 120 to about 400 m²/g.

Other Additives

In certain embodiments, the polymer composition does not comprise oil or toxic substitutes thereof. In certain embodiments, the polymer composition does not comprise surfactants. In certain embodiments, the polymer composition does not comprise additives which adversely impact the performance or stability of the composition.

In embodiments, one or more additional additives which increase the stability of the composition without increasing the viscosity, or otherwise adversely impacting performance, can be included in the composition. In certain embodiments, the one or more additional additives includes a stabilizer that is not water soluble. Such stabilizers can be selected from, for example, imidazelinium compounds (such as Fennobulk 889-100, available from Kemira Oyj), quaternary ammonium compounds (such as Adogen® 66, available from Evonik), and compositions including modified bentonite clays (such as Bentone® 155, available from Elementis Specialties), phosphates and/or sulfates.

In certain embodiments, the one or more additives can be mixed with the DPAM prior to adding to the aqueous dispersant, for example by dry milling the one or more additives with the DPAM prior to the addition of the dispersant. In certain embodiments, the one or more additives comprise calcium stearate and/or stearic acid. For example, calcium stearate (Force Chem Technologies and BKM Resources), or stearic acid (Alfa Chemical Corp and Aldon Corp), can be dry milled with the DPAM prior to the addition of aqueous dispersant. Those of ordinary skill in the art will recognize that the polymer composition may further contain additional additives such as initiators, activators, bases, combinations thereof, and a variety of other suitable additives.

Methods of Preparing the Polymer Compositions

In certain embodiments, a method of preparing the polymer compositions comprises:

(a) combining an aqueous solution of one or more dispersants with a dry polyacrylamide to form a mixture;

(b) blending or mixing the resultant mixture;

(c) combining the resultant mixture with fumed silica and one or more alkali metals or ammonium salts; and

(d) blending or mixing the resultant mixture to form the polymer composition.

In certain embodiments, a method of preparing the polymer compositions comprises:

(a) combining an aqueous solution of one or more dispersants with a dry polyacrylamide and fumed silica to form a mixture;

(b) blending or mixing the resultant mixture;

(c) combining the resultant mixture with one or more alkali metals or ammonium salts; and

(d) blending or mixing the resultant mixture to form the polymer composition.

In certain embodiments, a method of preparing the polymer compositions comprises:

(a) combining an aqueous solution of one or more dispersants and one or more alkali metals or ammonium salts with a dry polyacrylamide and fumed silica to form a mixture; and

(b) blending or mixing the resultant mixture to form the polymer composition.

In certain embodiments, the method further comprises combining dry polyacrylamide and fumed silica prior to step (a) and optionally blending or mixing the dry polyacrylamide and fumed silica. In embodiments, the blending or mixing of the dry polyacrylamide powder and fumed silica can be accomplished by any suitable means, for example, by shaking, vibrating or mixing, for example until both the dry polyacrylamide powder and fumed silica are uniformly mixed. In embodiments, the blending of the dry polyacrylamide powder with the fumed silica can be carried out in any manner so long as the polymer particles are substantially coated with the fumed silica. In embodiments, the blending of the dry polyacrylamide powder with the fumed silica is carried out by low shear mixing such as rotary batch mixer or fluidized bed mixer. In embodiments, the blending of the dry polyacrylamide powder with the fumed silica is mixed for a period of about 30 to about 60 minutes.

In certain embodiments, the aqueous solution of the one or more dispersants is prepared by adding the one or more dispersants to water and optionally adjusting the pH of the dispersant solution. In embodiments, the aqueous solution of one or more dispersants has been adjusted to a pH of about 5 to about 11. In embodiments, the aqueous solution of one or more dispersants has been adjusted to a pH of about 6 to about 8 and one or more alkali metals or ammonium salts or acids were added. In certain embodiments, the aqueous solution of one or more dispersants does not comprise the one or more alkali metals or ammonium salts.

In embodiments, the aqueous solution of the one or more dispersants is prepared by adding the dispersant to water and mixing, and then optionally, adjusting the pH of the dispersants solution by adding acid or base.

In embodiments, when combining the dispersant solution with the blend of the dry polyacrylamide powder and the fumed silica to form a mixture, the mixture should be mixed or blended for about 30 minutes to about 2 hours. In embodiments, the blending of the aqueous solution of the one or more dispersants, which may optionally include one or alkali metal or ammonium salts, and the dry polyacrylamide powder with the fumed silica is carried out by high speed mixing, for example overhead mixing at about 450 to about 10000 RPM, or by magnetic stirring. In embodiments, the blending or mixing of the aqueous solution of one or more dispersants, dry polyacrylamide and fumed silica mixture should be carried out such that dry powder or solids do not build up on the surface of the mixture. For example, the blending or mixing of the aqueous solution of one or more dispersants, dry polyacrylamide and fumed silica can be carried out mixing or agitating the aqueous solution of one or more dispersants to create a vortex, then adding the dry polyacrylamide powder with, or before, the fumed silica to the vortex in the aqueous solution, and continuing to mix or agitate the aqueous solution to form the mixture. In certain embodiments, the dispersant solution is stirred, for example at a sufficiently high speed, to create a vortex prior to adding the dry polyacrylamide powder. In embodiments, the aqueous solution of one or more dispersants and the dry polyacrylamide with the fumed silica can be combined by any means necessary to prepare the polymer composition. In certain embodiments, the fumed silica is not added to the aqueous solution of one or more dispersants in the absence of the polyacrylamide powder.

In certain embodiments, the particle size of the dry polyacrylamide can be reduced by grinding polymer composition, for example in a homogenizer or mixer, such as a colloid mill, or another known method for reducing the size of solid particles suspended in a fluid. For example, a composition could be prepared using a dry polyacrylamide with a particle size of greater than about 1 mm and passing the composition through a homogenizer or mixer. Pressure, and the number of passes through the homogenizer or mixer, should be adjusted as necessary to provide the desired particle size, stability and performance.

In certain embodiments, a method of preparing the polymer composition comprises: (a) providing a polymer gel comprising polyacrylamide polymer or copolymer with particle size of about 1 mm or greater, fumed silica, one or more dispersants, one or more alkali metal or ammonium salts, and water, wherein the polymer gel has a polymer solids content of about 25% to about 35% by weight; and (b) grinding the polymer gel to form the polymer composition. In embodiments, the grinding of the polymer gel can be accomplished by passing the polymer gel through a homogenizer or mixer. In embodiments, the method comprises passing the polymer gel through a homogenizer or mixer, for example a colloid mill. Pressure, and the number of passes through the homogenizer or mixer, may be adjusted as necessary, for example, to provide the desired particle size, stability and/or performance.

In certain embodiments, a method of preparing the polymer composition comprises: (a) providing a polymer gel comprising polyacrylamide polymer or copolymer with particle size of about 1 mm or greater, fumed silica, one or more dispersants, one or more alkali metal or ammonium salts, and water, wherein the polymer gel has a polymer solids content of about 25% to about 35% by weight; and (b) passing the polymer gel through a homogenizer or mixer to form the polymer composition.

In certain embodiments, a method of preparing the polymer composition comprises: (a) providing a polymer gel comprising polyacrylamide polymer or copolymer with particle size of about 1 mm or greater, fumed silica, one or more dispersants, one or more alkali metal or ammonium salts, and water, wherein the polymer gel has a polymer solids content of about 25% to about 35% by weight; and (b) passing the polymer gel through a colloid mill to form the polymer composition.

Treatment Fluid

In embodiments, a treatment fluid, for example a well treatment fluid, containing the polymer compositions described herein, can be used in any well treatment fluid where friction reduction is desired including but not limited to stimulatio got-and completion operations. For example, the well treatment fluid can be used for hydraulic fracturing applications. Conventional fracturing fluids typically contain natural or synthetic water soluble polymers, which are well known in the art. In embodiments, the polymer composition is present in an amount sufficient to reduce friction without forming a gel.

In embodiments, the treatment fluid is formed by mixing additional water with the polymer composition. The additional water may be freshwater, saltwater, brine, seawater, or combination thereof. Generally, the water may be from any source, provided that it does not contain an excess of compounds that may adversely affect other components in the aqueous treatment fluid or the formation itself. In certain embodiments, the concentration of the polyacrylamide in the treatment fluid is in the range of about 2 ppm to about 1000 ppm by weight of the treatment fluid.

In applications, the well treatment fluid can be configured as a gelled fluid, a foamed gel fluid, acidic fluid, water and potassium chloride treatments, and the like. The fluid may be injected at a pressure effective to create one or more fractures in the subterranean formation. Depending on the type of well treatment fluid utilized, various additives may also be added to the fracturing fluid to change the physical properties of the fluid or to serve a certain beneficial function. In one embodiment, the fluid does not contain a sufficient amount of water soluble polymer to form a gel. Optionally, fluid loss agents may be added to partially seal off the more porous sections of the formation so that the fracturing occurs in the less porous strata. Other oilfield additives that may also be added to the fracturing fluid include emulsion breakers, antifoams, scale inhibitors, H₂S and or O₂ scavengers, biocides, crosslinking agents, surface tension reducers, breakers, buffers, surfactants and non-emulsifiers, fluorocarbon surfactants, clay stabilizers, fluid loss additives, foamers, friction reducers, temperature stabilizers, diverting agents, shale and clay stabilizers, paraffin/asphaltene inhibitors, corrosion inhibitors, and acids. For example, an acid may be included in the aqueous treatment fluids, among other things, for a matrix or fracture acidizing treatment. In a particular embodiment, the treatment fluid further comprises a biocide.

Methods of Use

In embodiments, a method for improving the stability of a polymer composition comprising dry polyacrylamide powders and water, comprises: combining dry polyacrylamide powder, fumed silica, one or more alkali metal or ammonium salts, and one or more dispersants to form a polymer composition. In embodiments, the stability (i.e. resistance to separation or other degradation) of the resulting polymer composition is greater than that of a corresponding composition without fumed silica and one or more alkali metal or ammonium salts.

In an embodiment, a method for improving friction reduction properties of an aqueous treatment fluid, comprises: (i) providing a polymer composition as described herein; and (ii) adding the polymer composition to an aqueous treatment fluid containing brine; wherein the resultant aqueous treatment fluid has an improvement in friction reduction, when compared to a similar aqueous treatment fluid in which the polymer composition does not contain fumed silica and one or more alkali metal or ammonium salts. In certain embodiments, the polymer composition further comprises an emulsifier. In one embodiment, the improved friction reduction property is the percent friction reduction of the aqueous treatment fluid. In one embodiment, the friction reduction in water, for example tap water, is in the range of about 40% and about 65%. In one embodiment, the time to achieve maximum friction reduction in water, for example tap water, is about 50 to about 80 seconds.

The polymer compositions and aqueous treatment fluids of the present embodiments may be used in any subterranean treatment where the reduction of friction is desired. Such subterranean treatments include, but are not limited to, drilling operations, stimulation treatments, and completion operations. Those of ordinary skill in the art, with the benefit of this disclosure, will be able to recognize a suitable subterranean treatment where friction reduction may be desired.

In embodiments, a method of treating a portion of a subterranean formation is provided, comprising: providing an aqueous treatment fluid of the present embodiments comprising a polymer composition as described herein, and introducing the aqueous treatment fluid into the portion of the subterranean formation. In some embodiments, the aqueous treatment fluid may be introduced into the portion of the subterranean formation at a rate and pressure sufficient to create or enhance one or more fractures in the portion of the subterranean formation. The portion of the subterranean formation that the aqueous treatment fluid is introduced will vary dependent upon the particular subterranean treatment. For example, the portion of the subterranean formation may be a section of a well bore, for example, in a well bore cleanup operation. In the stimulation embodiments, the portion may be the portion of the subterranean formation to be stimulated.

In embodiments, the methods may further comprise preparing the aqueous treatment fluid. Preparing the aqueous treatment fluid may comprise providing a polymer composition as described herein, and combining the polymer composition with water or brine to form the aqueous treatment fluid.

The polymer compositions and aqueous treatment fluids of the present embodiments may also be used in any methods of treating aqueous streams, for example as a flocculant. The polymer compositions and aqueous treatment fluids may be used in any aqueous stream where flocculation treatment is desired, or in any aqueous stream where aggregation of particles in a suspension is desired.

The following examples are presented for illustrative purposes only, and are not intended to be limiting.

### EXAMPLES

Abbreviations

DPAM dry polyacrylamide

SV standard viscosity

GPTG gallons per thousand gallons

FR friction reduction

Tmax time to reach maximum FR

T90 time to reach 90% of maximum FR

PAA poly acrylic acid

AMD acrylamide

### Example 1

### Preaparation and Stability of Exemplary and Comparative Polymer Compositions

In this example, exemplary and comparative polymer compositions are prepared, and their stability over time evaluated.

In preparing the exemplary polymer compositions, the DPAM should appear to go into the dispersion with minimal increase in viscosity. If the DPAM appeared to agglomerate, not go in quickly or there was a high increase in viscosity, this meant that the DPAM was dissolving which would then swell and form a gel.

Comparative compositions A, B, and D and Exemplary composition C were prepared, each containing 12% of a dried 25/75 acrylate/acrylamide copolymer (<300 μm particle size), 18.4% dried dispersant of acrylate 2-acrylamido-2-methylpropane sulfonic acid copolymer, ˜63% water, 6% ammonium hydroxide, by weight. The pH of each composition was about 6.5. Fumed silica (0.36%) and/or sodium sulfate (1.5%) were added to certain samples, as specified in Tables 1 and 2 below, and the balance of the composition was water. The samples were subsequently stored on a shelf at room temperature for 90 days or in a flowing air oven at 50° C. for 90 days. Observations on the appearance of the samples over time are provided in Tables 1 and 2.

TABLE 1
Appearance of Polymer Compositions at Room
Temperature

| | Fumed | Sodium | | | |
|---|---|---|---|---|---|
| Sample | Silica (%) | Sulfate (%) | Day 0 | Day 5 | Day 90 |
| A | 0 | 0 | thin | thin, separate | thin, separate |
| B | 0.36 | 0 | thin | thin, | thin, |
| | | | | homogeneous | homogeneous |
| C | 0.36 | 1.5 | thin | thin, | thin, |
| | | | | homogeneous | homogeneous |
| D | 0 | 1.5 | thin | thin, separate | thin, separate |

TABLE 2
Appearance of Polymer Compositions at 50° C.

| | Fumed | Sodium | Day | | |
|---|---|---|---|---|---|
| Sample | Silica (%) | Sulfate (%) | 0 | Day 5 | Day 90 |
| E | 0 | 0 | thin | High viscous, | High viscous, |
| | | | | separate | separate |
| F | 0.36 | 0 | thin | medium-viscous, | high viscous, |
| | | | | homogeneous | homogeneous |
| G | 0.36 | 1.5 | thin | thin, | Medium |
| | | | | homogeneous | viscosity, |
| | | | | | homogeneous |
| H | 0 | 1.5 | thin | High viscous | High viscous, |
| | | | | | separate |

At room temperature, the compositions without fumed silica separated in 5 days, while those including fumed silica maintained stability (remained homogeneous) for 90 days. At 50° C., the compositions without both fumed silica and sodium sulfate separated or became more viscous in 5 days, while those including fumed silica maintained stability (remained homogeneous) for 90 days.

### Example 2

### Preparation and Stability of Exemplary and Comparative Polymer Compositions

Exemplary polymer compositions were prepared containing 10-15% of a 25/75 acrylate/AMD copolymer (<300 μm particle size and SV in the range of about 5 to about 8) and 16.8-20.7% acrylate/AMD copolymer dispersant in water, as specified in Tables 3 and 4, below. The pH of each composition was adjusted to 7 with ammonium hydroxide. Fumed silica (0.2-0.5%) and sodium sulfate (1.3-1.8%) were added to certain samples, as specified in Tables 3 and 4 below, and the balance of the composition was water. Exemplary Samples I-L were subsequently stored on a shelf at room temperature for 90 days, and exemplary Samples M-O were stored in a flowing air oven at 55° C. for 90 days. Observations on the appearance of the samples over time are provided in Tables 3 and 4.

TABLE 3
Appearance of Exemplary Polymer Compositions at Room
Temperature

| | DPAM | Dispersant | Fumed | Sodium | Day | Day | Day |
|---|---|---|---|---|---|---|---|
| Sample | (%) | (%) | Silica (%) | Sulfate (%) | 0 | 30 | 90 |
| I | 10 | 18.4 | 0.2 | 1.3 | very | thin | thin |
| | | | | | thin | | |
| J | 12 | 18.4 | 0.4 | 1.3 | very | very | very |
| | | | | | thin | thin | thin |
| K | 13.5 | 16.8 | 0.4 | 1.8 | thin | thin | thin |
| L | 15 | 20.7 | 0.5 | 1.5 | thin | thin | thin |

TABLE 4
Appearance of Exemplary Polymer Compositions at 55° C.

| | | | Fumed | Sodium | | | |
|---|---|---|---|---|---|---|---|
| | DPAM | Dispersant | Silica | Sulfate | Day | | |
| Sample | (%) | (%) | (%) | (%) | 0 | Day 30 | Day 90 |
| M | 10 | 18.4 | 0.2 | 1.3 | thin | thin | thin |
| N | 12 | 18.4 | 0.4 | 1.5 | thin | thin | medium |
| O | 13.5 | 18.4 | 0.4 | 1.5 | thin | medium | N/A |

At room temperature, all of the exemplary compositions including 10-15% DPAM maintained stability (remained thin and homogeneous) for 90 days. At 55° C., the compositions including 10-12% DPAM maintained stability for 90 days.

### Example 3

### Friction Reduction Testing of Exemplary and Comparative Polymer Compositions

In this example, friction reduction characteristics were evaluated for exemplary polymer composition samples and comparative polymer composition samples. The friction reduction characteristics of the exemplary and comparative polymer composition samples were evaluated in a laboratory scale friction loop apparatus. The friction loop is a laboratory instrument designed to simulate well fracturing flow conditions. Fracturing in the field often requires pumping over 50 barrels per minute through a bore approximately 4.5″ diameter which can result in a highly turbulent flow (Reynolds number: 500,000 to 5,000,000). Although it is not possible to achieve this kind of flow in the lab, the friction loop apparatus is designed to simulate the field conditions to the maximum known extent (Reynolds number: 120,000). The data generated by this laboratory scale friction loop is widely accepted by the industry. The main components of the friction loop are: centrifugal pump, magnetic flow meter and a differential pressure transmitter to create and monitor necessary conditions. All pipes and other components are constructed using stainless steel 316L/304L material.

To test the friction reduction property of the polymer composition samples, the friction loop reservoir was filled with 20 L of tap water, or 2% KCl aqueous solution (at a temperature of 71° F.±3). The tap water/KCl solution was circulated through the friction loop apparatus at a flow rate of 24 gallons per minute across a five-foot section of half-inch diameter pipe (required to generate the above-mentioned Reynolds number). A baseline pressure drop was measured across the five-foot section of pipe. The polymer compositions were then added to the circulating tap water at a specified dosage (0.5 gallons of polymer per thousand gallons of tap water—GPTG). The degree of friction reduction (% FRₜ) at a given time ‘t’ was calculated from the initial baseline pressure drop ΔPᵢ and the pressure drop at time t, ΔPₜ using the equation:

$$\% {FR}_{t} = \frac{Δ {P}_{i} - Δ {P}_{t}}{Δ {P}_{i}} \times 100$$

The Max FR (maximum friction reduction), Tmax (time (seconds) to maximum friction reduction), and T90 (time (seconds) to 90% max friction reduction, which is a simple measure of the inversion rate of the polymer) were also measured. The results are recorded in Table 5.

Friction Loop results of comparative and exemplary samples A-D of Example 1 are shown in Table 5.

TABLE 5
Friction Reduction Tests Results of Polymer Compositions

| | Fumed | Sodium | Tap Water | | | 2% KCl | | |
|---|---|---|---|---|---|---|---|---|
| | Silica | Sulfate | FR | Tmax | T90 | FR | Tmax | T90 |
| Sample | (%) | (%) | (%) | (sec) | (sec) | (%) | (sec) | (sec) |
| A | 0 | 0 | 63 | 79 | 39 | 44 | 131 | 48 |
| B | 0.36 | 0 | 63 | 78 | 38 | 44 | 130 | 49 |
| C | 0.36 | 1.5 | 63 | 82 | 40 | 43 | 122 | 48 |
| D | 0 | 1.5 | 63 | 83 | 38 | 44 | 132 | 50 |

The results show that the addition of fumed silica and/or sodium sulfate additions did not substantially change friction reduction performance, compared to Sample A, which included neither fumed silica or sodium sulfate.

compositions were prepared, Sample P containing 10% dried polymer with 14/86 acrylate/AMD (<300 μm particle size and 4.9 SV) with 18.1% of a 60/40 polyacrylate/AMPS dispersant in water, and Sample Q containing 13% dried polymer with 25/75 acrylate /AMD (<300 μm particle size and SV in the range of about 5 to about 8) with 16.8% of a 60/40 polyacrylate/AMPS dispersant in water. The pH of each composition was adjusted to 7 with ammonium hydroxide. Fumed silica (0.4%) and sodium sulfate (1.5-1.7% as specified in Table 6) were added to the samples, and the balance of the composition was water.

The compositions were subjected to the standard friction reduction test, described above. The dosage of each composition was 0.5 GPT and tests were conducted in tap water, sea water and in a 2% KCl aqueous solution. The sea water sample was prepared using 3.4 wt % Instant Ocean® Synthetic Sea Salt. The results are shown in Table 6.

TABLE 6
Friction Reduction Tests Results of Exemplary Polymer
Compositions

| | | | | | Tap | 2% | Sea |
|---|---|---|---|---|---|---|---|
| | | | Fumed | Sodium | Water | KCl | Water |
| | DPAM | Dispersant | Silica | Sulfate | FR | FR | FR |
| Sample | (%) | (%) | (%) | (%) | (%) | (%) | (%) |
| P | 10 | 18.1 | 0.4 | 1.7 | 60 | 50 | 42 |
| Q | 13 | 16.8 | 0.4 | 1.5 | 66 | 61 | 50 |

The results show samples with 10-13% DPAM provide good friction reduction performance in tap water, 2% KCl and Sea Water.

### Example 4

### Friction Reduction Testing of Exemplary Polymer Compositions at Various Dosages

An exemplary polymer composition was prepared as follows. First, a dispersant solution was prepared by first adding 512 g of aqueous acrylate 2-acrylamido-2-methylpropane sulfonic acid copolymer dispersant to 490 g DI water, and adjusting the pH to 7 with 108 g ammonium hydroxide. To the dispersant solution was added 19.6 g sodium sulfate and the resultant solution was stirred. Next, 12 g of a dry 25/75 acrylate/AMD copolymer (<300 μm particle size) was mixed with 4.48 g fumed silica. The dispersant solution was poured into the fumed silica and copolymer. The mixture was blended at 800 rpm and mixed for two hours.

The resulting polymer composition was thin and homogeneous and was stable even after one month at room temperature. The polymer composition passed pourability and bulk viscosity tests, and three freeze-thaw cycles. The pourability test is a qualitative assessment of the ability of a material to flow through a funnel, for example a large, powder plastic funnel. The test included pouring the polymer composition at room temperature through a funnel and observing the results. Compositions which successfully flowed through the funnel were deemed to have passed the test. The measured bulk viscosity of the sample was 600 cP after 1 month (#2 spindle and 12 rpm). Each freeze-thaw cycle included hard freezing of the sample at −30° C. for 24 hours, allowing the sample to warm to room temperature and observing the state of the sample at room temperature (e.g. solid or thawed). After three freeze-thaw cycles, the samples of the exemplary polymer compositions remained thin and homogeneous, substantially similar to their initially observed physical properties at room temperature. Standard friction reduction tests as described above were carried out on the polymer in sea water, tap water and 2% KCl with varying doses of the composition. The results are shown in Table 7.

TABLE 7
Friction Reduction Test Results of An Exemplary Polymer
Composition At Various Dosages

| | Sea Water | | | 2% KCl | | | Tap Water | | |
|---|---|---|---|---|---|---|---|---|---|
| Dose | FR | Tmax | T90 | FR | Tmax | T90 | FR | Tmax | T90 |
| (GPT) | (%) | (sec) | (sec) | (%) | (sec) | (sec) | (%) | (sec) | (sec) |
| 0.5 | 46 | 103 | 42 | 55 | 92 | 35 | 61 | 73 | 36 |
| 1 | 52 | 105 | 34 | 62 | 90 | 34 | 66 | 68 | 28 |
| 1.5 | 58 | 104 | 31 | | | | | | |

In the preceding procedures, various steps have been described. It will, however, be evident that various modifications and changes may be made thereto, and additional procedures may be implemented, without departing from the broader scope of the procedures as set forth in the claims that follow.

1. A polymer composition comprising: one or more polyacrylamide powders, one or more dispersants, one or more alkali metal or ammonium salts, fumed silica and water.

2. The polymer composition of claim 1, wherein the polymer composition remains substantially homogeneous, stable and free-flowing for at least about 1 day without agitation.

3. The polymer composition of claim 1, wherein the polymer composition remains substantially homogeneous, stable and free-flowing for at least about 1 month without agitation.

4. The polymer composition of claim 1, wherein the composition comprises about 2% to about 24% of the one or more polyacrylamide powder solids by weight of the total composition.

5. The polymer composition of claim 1, wherein the pH of the composition is about 5 to about 10.

6. The polymer composition of claim 1, wherein the standard viscosity is in the range of about 2 to about 9.

7. The polymer composition of claim 1, wherein the composition comprises about 0.5 to about 4% of the one or more alkali metal or ammonium salts by weight of the total composition.

8. The polymer composition of claim 1, wherein the composition comprises about 0.1 to about 0.7% of the fumed silica by weight of the total composition.

9. The polymer composition of claim 1, wherein the composition comprises about 30 to about 50% by weight aqueous dispersants.

10. The polymer composition of claim 1, wherein the one or more polyacrylamide powders has a solids content of about 88% to about 100%,

11. The polymer composition of claim 1, wherein
the fumed silica is hydrophilic fumed silica or untreated fumed silica.

12. A method of preparing a polymer composition according to claim 1, comprising:
(a) combining an aqueous solution of one or more dispersants with dry polyacrylamide to form a mixture;
(b) blending or mixing the mixture;
(c) combining fumed silica and one or more alkali metals or ammonium salts with the mixture; and
(d) blending or mixing the resultant mixture to form the polymer composition.

13. A method of preparing a polymer composition according to claim 1 comprising:
(a) combining an aqueous solution of one or more dispersants with dry polyacrylamide and fumed silica to form a mixture;
(b) blending or mixing the mixture;
(c) combining one or more alkali metals or ammonium salts with the mixture; and
(d) blending or mixing the mixture to form the polymer composition.

14. A method of preparing a polymer composition according to claim 1 comprising:
(a) combining an aqueous solution comprising one or more dispersants and one or more alkali metals or ammonium salts with dry polyacrylamide and fumed silica to form a mixture; and
(b) blending or mixing the mixture to form the polymer composition.

15. The method of claim 12, wherein the particle size of the dry polyacrylamide is reduced by grinding the polymer composition.

16. The method of claim 12, wherein the particle size of the dry polyacrylamide is reduced by passing the polymer composition through a homogenizer or a mixer.

17. A treatment fluid comprising a polymer composition according to claim 1 and additional water.

18. A method for improving the stability of a polymer composition comprising dry polyacrylamide powders and water, the method comprising: combining dry polyacrylamide powder, fumed silica, one or more alkali metal or ammonium salts, and an aqueous solution of one or more dispersants to form a polymer composition.

19. A method for improving friction reduction properties of an aqueous treatment fluid, comprising: (i) providing a polymer composition according to claim 1; and (ii) adding the polymer composition to an aqueous treatment fluid containing brine; wherein the resultant aqueous treatment fluid has an improvement in friction reduction, when compared to a similar aqueous treatment fluid in which the polymer composition does not contain fumed silica and one or more alkali metal or ammonium salts.

20. A method of treating a portion of a subterranean formation, comprising: providing a treatment fluid of claim 15, and introducing the treatment fluid into the portion of the subterranean formation.
